(19) United States
(12) Patent Application Publication
(10) Pub. No.: US 2009/0163398 A1
(43) Pub. Date: Jun. 25, 2009

(54) COMPOSITE PARTICLE

(75) Inventor: Masafumi Miyamoto, Wakayama (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KAO CORPORATION, Tokyo (JP)

(21) Appl. No.: 12/093,971

(22) PCT Filed: Nov. 14, 2006
(86) PCT No.: PCT/JP2006/323055

§ 371 Date: Jun. 19, 2008

(30) Foreign Application Priority Data
Nov. 16, 2005 (JP) 2005-331982
May 10, 2006 (JP) 2006-131173

(51) Int. Cl. C11D 3/386; C11D 17/06

(52) U.S. Cl. 510/224; 510/530

(57) ABSTRACT

The present invention provides a composite particle containing a paraffin wax with (1) a proteolytic enzyme and (1e) at least one enzyme activity stabilizer selected from borates, proteins, polyhydric alcohols and water-soluble polymers, or with (2) an amylolytic enzyme and (2e) at least one enzyme activity stabilizer selected from polyhydric alcohols, nonionic surfactants and water-soluble polymers, a detergent composition containing the composite particle, and a process for preparing the composite particle containing mixing the paraffin wax, the proteolytic enzyme, and the enzyme activity stabilizer, setting a temperature of a mixture to a softening temperature (or melting point) of the paraffin wax or more, and subjecting the mixture to cooling solidification to granulate.

### FIELD OF THE INVENTION

The present invention relates to a composite particle that forms an enzyme material having stability maintained when used in a liquid and a powder detergent composition, a process for producing the same, and a detergent composition containing the same.

### BACKGROUND OF THE INVENTION

In detergent compositions for automatic dishwashers, addition of a proteolytic enzyme (hereinafter, also simply referred to as an enzyme) thereto is very important for achieving high detergency. However, enzymes are easily deactivated by the presence of a large amount of water, contact with another agent, and autolysis of enzymes by themselves. For these reasons, in many cases, enzymes are generally granulated with water-soluble polymers such as polyethylene glycol and inorganic salts, and dried to provide dry granules, and the granules are blended in powder detergent compositions.

In rare cases, a powder detergent composition is not absolutely dissolved in tap water (which is called undissolved residue). In this case, not only the detergency of the composition is reduced, but also undissolved residue is accumulated on a drain outlet in a dishwasher and may prevent water discharge, which is a problem.

A detergent composition in a liquid form can solve the problem of undissolved residue. However, as described above, the enzyme is easily deactivated in the presence of a large amount of water, and thus stable formulation of the enzyme in a detergent composition is difficult. In particular, in many cases, a washing liquid is alkali for achieving high detergency for fat and oil. That is, a technique for maintaining high enzyme activity in the presence of much amount of alkali water is important for preventing the generation of undissolved residue of a detergent composition and achieving strong detergency of the enzyme. Recently, in a powder detergent composition, in many cases, a bleaching agent such as sodium percarbonate is blended to clean stains by tea incrustation. Such a composition affects the stability of an enzyme adversely. For this reason, also in a powder detergent composition, the technique for maintaining high enzyme activity is important.

Techniques for stabilizing enzymes have been conventionally investigated variously. For example, JP-A 11-193398 discloses a liquid detergent composition containing an alkali agent in which stability of an enzyme is increased by formulating a specific polymer.

JP-A 06-313200 discloses a technique for stabilizing an activity of a core particle by coating the core particle with paraffin.

### SUMMARY OF THE INVENTION

The present invention is a composite particle containing:
a paraffin wax and
(1) a proteolytic enzyme and
(1e) at least one enzyme activity stabilizer selected from borates, proteins, polyhydric alcohols and water-soluble polymers, or
(2) an amylolytic enzyme and
(2e) at least one enzyme activity stabilizer selected from polyhydric alcohols, nonionic surfactants and water-soluble polymers.

Embodiment (1) of the present invention relates to a composite particle containing a paraffin wax, a proteolytic enzyme, and at least one enzyme activity stabilizer selected from borates, proteins, polyhydric alcohols and water-soluble polymers, and a detergent composition containing the composite particle.

Embodiment (1) of the present invention also relates to a process for producing the composite particle containing: mixing the paraffin wax, the proteolytic enzyme, and at least one enzyme activity stabilizer selected from borates, proteins, polyhydric alcohols and water-soluble polymers; setting a temperature of a mixture to a softening temperature (or melting point) of the paraffin wax or more; and subjecting the mixture to cooling solidification to granulate.

Embodiment (2) of the present invention relates to a composite particle containing a paraffin wax, an amylolytic enzyme, and at least one enzyme activity stabilizer selected from polyhydric alcohols, nonionic surfactants and water-soluble polymers, and a detergent composition containing the composite particle.

Embodiment (2) of the present invention also relates to a process for producing the composite particle containing; mixing the paraffin wax, the amylolytic enzyme, and at least one enzyme activity stabilizer selected from polyhydric alcohols, nonionic surfactants and water-soluble polymers; setting a temperature of a mixture to a softening temperature (or melting point) of the paraffin wax or more; and cooling to solidify.

### DETAILED DESCRIPTION OF THE INVENTION

Effect of the invention of JP-A 11-193398 is not sufficient.

When an enzyme is used as the core particle as described in JP-A 06-313200, it cannot achieve sufficient stability only with a paraffin coating in alkali water and in powder detergent compositions containing sodium percarbonate.

The present invention is intended to solve the problems described above and to provide a composite particle containing an enzyme of which activity is highly stabilized, a process for producing the same, and a detergent composition containing the same.

The present inventors have found that a blend of a specific enzyme activity stabilizer in a particle containing an enzyme can enhance stability of the enzyme.

In the composite particle of the present invention, the activity of the enzyme is highly stabilized. According to the present invention, a detergent composition having good compounding stability for a long time while containing an enzyme can be provided.

Embodiment (1) of the present invention will be described in detail below.

### [Proteolytic Enzyme]

The proteolytic enzyme used in the present invention can be any enzyme as long as it degrades a protein. Examples of a commercially available enzyme include Esperase, Savinase, Everlase, Kannase, Polarzyme (registered marks; Novozymes), Properase, Purafect, and Purafect Ox (registered marks; Genencor). Those also can be used, including an alkaline protease described in WO 99/18218, and variant alkaline proteases described in JP-A-2002-218989, JP-A-2004-122, JP-A-2004-57195, JP-A-2004-305175, and JP-A-2004-305176.

### [Enzyme Activity Stabilizer]

The enzyme activity stabilizer used in the present invention is selected from borates, proteins, polyhydric alcohols and water-soluble polymers. These may be used alone or in combination of two or more.

Preferred examples of borate include, but are not limited to, sodium borate and ammonium borates. There are different sodium borates of various combinations of sodium oxide and boron oxide. Any form thereof can be used. From the viewpoint of handling, borax represented as Na₂B₄O₇.10H₂O is preferred. As shown by the combined use of boric acid and ammonia, a similar effect can be achieved by combinations that form borates.

Preferred examples of the protein that can be used include gelatin, a neutralized casein and soybean protein.

Examples of the polyhydric alcohol include glycerol, polyethylene glycol, polypropylene glycol, sucrose, and trehalose.

Examples of the water-soluble polymer include polyvinyl alcohol, polyvinylpyrrolidone and the like. In the context, “water-soluble” refers to that having solubility in water of 1 g/100 g or more.

### [Paraffin Wax]

As the paraffin wax used in the present invention, those can be used include paraffin, microcrystalline wax, petrolatum, and the like. When the composite particle of the present invention is blended into a detergent composition for a common dishwasher, the composite particle preferably softens or melts at a washing temperature of the dishwasher to release the enzyme to the outside of the particle. A softening temperature (or melting point) of the paraffin wax is, from the point of storage stability, preferably 40° C. or more, and more preferably 45° C. or more. From the point of achieving good release of the enzyme in practical use, the temperature is also preferably 70° C. or less, and more preferably 60° C. or less. Wax components having a higher and lower melting point than the above may be mixed within the range that does not inhibit the mechanism. A melting point of a paraffin wax can be measured according to JIS K0064: 1992.

### [Composite Particle]

The composite particle of the present invention includes the paraffin wax, the proteolytic enzyme, and the enzyme activity stabilizer as main ingredients, and may also include other ingredients such as inorganic and organic pigments, colorants such as organic dyes, surfactants, silicone compounds, and antioxidants within the range that does not affect the effect of the present invention.

From the points of achieving sufficient protective effect for the enzyme and securing a sufficient enzyme ratio, the content of the paraffin wax in the composite particle is preferably 50 to 99.9% by weight, more preferably 70 to 99% by weight, and even more preferably 85 to 97% by weight.

From the points of achieving sufficient protective effect for the enzyme and securing a sufficient enzyme ratio, the content of the proteolytic enzyme in the composite particle is preferably 0.1 to 50% by weight, and more preferably 0.5 to 10% by weight.

From the points of achieving sufficient protective effect for the enzyme and securing a sufficient enzyme ratio, the content of the enzyme activity stabilizer in the composite particle is 1 to 1000 parts by weight, more preferably 10 to 500 parts by weight, and even more preferably 50 to 300 parts by weight to 100 parts by weight of proteolytic enzyme.

In context, a median particle diameter based on volume is a median diameter value measured in an aqueous solution of 0.1% laurylsulfuric acid ester sodium salt with a laser diffraction/dispersion type particle distribution measurement device. As the laser diffraction/dispersion type particle distribution measurement device, LA-920 (Horiba Ltd.) can be used, for example.

A shape of the composite particle of the present invention is preferably spherical, from the points of appearance and stability.

### [Process for Preparing Composite Particle]

The composite particle of the present invention can be prepared by mixing the paraffin wax, the proteolytic enzyme, and the enzyme activity stabilizer as described above, setting the temperature of a mixture to a softening temperature (or melting point) of the paraffin wax or more, cooling to solidify, and granulating.

The paraffin wax, the proteolytic enzyme, and the enzyme activity stabilizer may be mixed all at once, but preferably the enzyme and the enzyme activity stabilizer may be firstly dissolved in water to provide a homogeneous solution, and the solution may be dehydrated by a freeze and dry method or the like, thereby the enzyme and the enzyme activity stabilizer can be mixed homogeneously. In this case, the obtained dry powder is mixed with the paraffin wax to provide an ungranulated mixture.

Mixing of the dry powder and the paraffin wax is preferably performed to provide a homogeneous mixture at a softening temperature (or melting point) of the paraffin wax or more. Examples of a mixing means that can be used include a blast mill, a planetary mixer, a roll mill, a kneader, an extruder, a homomixer, and a bead mill.

The resultant ungranulated mixture can be granulated by various methods. A preferred granulating method is melt forming. Melt forming is a method of forming a paraffin wax at a temperature equal to or hither than the melting point of the paraffin wax, and cooling to solidify to provide a granulated product. Specific examples include roll-drop granulation, rote-form granulation, and melt-spray cooling. Melt-spray cooling is more preferably used.

Melt-spray cooling is a method of melting an ungranulated mixture, and spraying the mixture of a temperature equal to or hither than the softening temperature (or melting point) of the paraffin wax into a refrigerant to cool to solidify. The composite particle thus obtained is difficult to generate a crack and a hole on the surface thereof and can shield ingredients in the particle from environments.

Examples of a spraying method include use of a rotary disc atomizer, a single-fluid nozzle, and a double- or more multi-fluid nozzle. A temperature of spraying must be higher than a temperature at which good spraying properties can be achieved. The higher temperature reduces the melt fluidity of a matter to be sprayed more, and provides better spraying properties. The upper limit of the spraying temperature is not specifically set, but preferably is the pyrolysis point of the composition or less and the enzyme deactivation temperature or less.

Preferred spraying is a method of spraying the mixture together with a compressed gas into a refrigerant using a double- or more multi-fluid nozzle. As the compressed gas used as a fluid, compressed air and compressed nitrogen can be used. For the compressed gas used, a temperature thereof is preferably higher than the spraying temperature, because clogging of the nozzle part due to cooling can be prevented and a granule can be continuously prepared. The refrigerant is preferably in the gas phase. The air and nitrogen may be used. The temperature of the refrigerant is preferably 5 to 40° C.

### [Detergent Composition]

The detergent composition of the present invention includes the composite particle according to the present invention. The form thereof can be appropriately selected according to the application, and can be any form including liquid and powder.

From the point of securing sufficient detergency, the content of the composite particle according to the present invention in the detergent composition of the present invention is preferably 0.1 to 10% by weight, and more preferably 0.5 to 5% by weight.

The detergent composition of the present invention can combine known detergent ingredients such as a surfactant, a bivalent metal ion scavenger, an alkali agent, an anti-resoiling agent, and a bleaching agent.

Examples of the surfactant used in the detergent composition of the present invention include anionic surfactants, nonionic surfactants, amphoteric surfactants, and cationic surfactants. Anionic surfactants and nonionic surfactants are preferred.

Examples of the anionic surfactant include sulfuric acid ester salts of alcohols having 10 to 18 carbon atoms, sulfuric acid ester salts of alkoxylated alcohols having 8 to 20 carbon atoms, alkylbenzenesulfonates, paraffin sulfonates, α-olefin sulfonate, α-sulfofatty acid salt, α-sulfofatty acid alkyl ester salts, and fatty acid salts. Preferred are linear alkylbenzenesulfonates in which alkyl chains have 10 to 14 carbon atoms, more preferably 12 to 14 carbon atoms. As a counter ion of the anionic surfactant, alkaline metal ions and amines are preferred, and sodium, potassium, monoethanolamine, and diethanolamine are even more preferred.

Examples of the nonionic surfactant include polyoxyalkylene alkyl (an alkyl group has 8 to 20 carbon atoms) ethers, alkylpolyglucosides, polyoxyalkylene alkyl (an alkyl group has 8 to 20 carbon atoms) phenyl ethers, polyoxyalkylene sorbitan fatty acid (fatty acid has 8 to 22 carbon atoms) esters, polyoxyalkylene glycol fatty acid (fatty acid has 8 to 22 carbon atoms) esters, and polyoxyethylene polyoxypropylene block polymers. Polyoxyalkylene alkyl ethers obtained by adding 4 to 20 moles of alkylene oxide such as ethylene oxide or propylene oxide to an alcohol having 10 to 18 carbon atoms [those having an HLB value (calculated by the Griffin method) of 10.5 to 15.0, and preferably 11.0 to 14.5] are preferred.

The content of the surfactant in the detergent composition of the present invention is preferably 0.5 to 60% by weight, and more preferably 10 to 45% by weight for the powder detergent composition and 20 to 50% by weight for the liquid detergent composition. When the detergent composition of the present invention is a bleaching detergent composition or a detergent composition for an automatic dishwasher, the content of the surfactant is preferably 1 to 10% by weight, and more preferably 1 to 5% by weight.

Examples of the bivalent metal ion scavenger used in the detergent composition of the present invention include condensed phosphates such as tripolyphosphates, pyrophosphates, and orthophosphates; aluminosilicates such as zeolite; synthetic layer crystalline silicates; nitrilotriacetates; ethylenediaminetetraacetates; citrates; isocitrates; and polyacetal carboxylates. Among them, the crystalline aluminosilicate (synthetic zeolite) is more preferred. Among type A, type X, and type P zeolites, type A is more preferred. Synthetic zeolite preferably used is that having an average primary particle diameter of 0.1 to 10 μm, and more preferably 0.1 to 5 μm.

A content of the bivalent metal ion scavenger in the detergent composition of the present invention is preferably 0.01 to 50% by weight, and more preferably 5 to 40% by weight.

In the case of the powder detergent composition, examples of the alkali agent used in the detergent composition of the present invention include alkaline metal carbonates such as sodium carbonates, which are called collectively dense ash and light ash, and amorphous alkaline metal silicate such as JIS No. 1, No. 2, and No. 3. These inorganic alkali agents are effective for forming a skeleton of the particle in drying the detergent composition and can provide a detergent composition that is relatively hard and which has good fluidity. Examples of the alkali agent other than these include sodium sesquicarbonate and sodium hydrogen carbonate. Phosphates such as tripolyphosphate also have activity as an alkali agent. Examples of the alkali agent used in the liquid detergent composition include alkali agents described above, and sodium hydroxide, and mono-, di- and triethanolamines, which may be used as counterions to anionic surfactants.

The content of the alkali agent in the detergent composition of the present invention is preferably 0.01 to 80% by weight, and more preferably 1 to 40% by weight.

Examples of the anti-resoiling agent used in the detergent composition of the present invention include polyethylene glycols, carboxylic acid-based polymers, polyvinyl alcohols, and polyvinylpyrrolidones. Among them, carboxylic acid-based polymers have a function of scavenging a metal ion and an activity of dispersing solid particle stains from clothes into a washing bath, as well as a resoiling-preventing performance. The carboxylic acid-based polymer is a homopolymer or copolymer of acrylic acid, methacrylic acid, itaconic acid, and the like. When the polymer is a copolymer, it is preferably a copolymer of the above-described monomer with maleic acid, and preferably has a molecular weight of several thousand to a hundred thousand. In addition to the carboxylic acid-based polymer, polymers such as polyglycidate, cellulose derivatives such as carboxymethylcellulose, and aminocarboxylic acid-based polymers such as polyaspartic acid are preferred because these have functions as a metal ion scavenger and a dispersing agent, and a resoiling-preventing performance.

The content of the anti-resoiling agent in the detergent composition of the present invention is preferably 0.001 to 10% by weight, and more preferably 1 to 5% by weight.

Examples of the bleaching agent used in the detergent composition of the present invention include hydrogen peroxide and percarbonate. The content of the bleaching agent in the detergent composition of the present invention is preferably 1 to 10% by weight.

When the bleaching agent is used, tetraacetylethylenediamine (TAED) and bleaching activators (activators) described in, for example, JP-A 06-316700 can be blended. The content of the bleaching activator in the detergent composition of the present invention is preferably 0.01 to 10% by weight.

The detergent composition of the present invention may further contain other additives such as a fluorescent material, a builder, a softening agent, a reductant (e.g., sulfite), a foam suppressing agent (e.g., silicone), and a flavorant.

The detergent composition of the present invention can be used as a detergent composition for hard surface, a bleaching detergent composition, and a detergent composition for clothes, and the like. It is especially useful as a detergent composition for automatic dishwashers.

Embodiment (2) of the present invention will be described in detail only in the points different from embodiment (1).

### [Amylolytic Enzyme]

The amylolytic enzyme used in the present invention is not specifically limited as long as it is an enzyme degrading starch. For example, the amylolytic enzyme can be obtained by culturing an amylase-productive bacterium belonging to the genus Bacillus (Bacillus sp.), and collecting the enzyme from the culture medium thereof. Examples of the amylase include amylases produced by microorganisms, for example, deposited under Bacillus sp. KSM-K36 (FERM BP-16816) and Bacillus sp. KSM-K38 (FERM BP-16817) with National Institute of Bioscience and Human-Technology, variants thereof, and transformants having a gene encoding the enzyme. Among them, amylases produced by Gram-positive bacteria are preferred. Amylases derived from Bacillus sp and mutant enzymes or enzyme variants of amylase having been improved in detergent performance are more preferred. These enzymes can be prepared by culturing bacteria producing these enzymes and transformants having genes encoding these enzymes, and collecting these enzymes from cultures thereof. Examples of a commercial product include: as an α-amylase, enzymes obtained from Bacillus licheniformis and Bacillus subtilis such as “Termamyl” (registeredmark, Novo Industry Co. Ltd.,) and “Maxamyl” (registered mark, Gist-Brocades); as a β-amylase, enzymes obtained from bacteria such as Bacillus sp. and from soybean and malt such as “Amano” (registered mark, Amano Enzyme Inc.), “multitome” (registered mark, Nagase Biochemicals, Ltd.); as a pullulanase, “Splentase” (registered mark, Amano Enzyme Inc.) and “Promozyme 200L” (registered mark, Novo Industry Co. Ltd.,); and as an isoamylase, “isoamylase” (reagent, Seikagaku Kogyo)

### [Enzyme Activity Stabilizer]

The enzyme activity stabilizer used in embodiment (2) of the present invention is selected from polyhydric alcohols, nonionic surfactants and water-soluble polymers. Those may be used alone or in combination of two or more.

Examples of the polyhydric alcohol include the same as in embodiment (1).

Examples of the nonionic surfactant include polyoxyalkylene alkyl (an alkyl group has 8 to 20 carbon atoms) ethers, alkyl (an alkyl group has 8 to 20 carbon atoms) polyglycosides, polyoxyalkylene alkyl (an alkyl group has 8 to 20 carbon atoms) phenyl ethers, polyoxyalkylene sorbitan fatty acid (fatty acid has 8 to 22 carbon atoms) esters, polyoxyalkylene glycol fatty acid (fatty acid has 8 to 22 carbon atoms) esters, and polyoxyethylene polyoxypropylene block polymers. Among them, polyoxyalkylene alkyl ethers obtained by adding 4 to 20 moles of alkylene oxide such as ethylene oxide or propylene oxide to an alcohol having 10 to 18 carbon atoms [those having an HLB value (calculated by the Griffin method) of 10.5 to 15.0, and preferably 11.0 to 14.5] are preferred.

Examples of the water-soluble polymer include polyvinyl alcohols, polyvinylpyrrolidones, gelatin, neutralized casein, and soybean proteins. In context, “water-soluble” refers to having solubility in water of not less than 1 g/100 g.

### [Composite Particle]

The composite particle according to embodiment (2) of the present invention contains the paraffin wax, the amylolytic enzyme and the enzyme activity stabilizer described above as main ingredients, and may further contain other ingredients such as inorganic and organic pigments, colorants such as organic dyes, surfactants other than nonionic surfactants, silicone compounds and antioxidants, within the range that does not impair the effect of the present invention.

From the point of stably keeping enzyme activity, a median particle diameter based on the volume of the composite particle according to embodiment (2) of the present invention is preferably 100 μm or more, and more preferably 200 μm or less. The upper limit thereof is not specifically limited, but from the point of appearance, the diameter is preferably not more than 5 mm, and more preferably not more than 2 mm.

### [Process for Preparing Composite Particle]

The composite particle according to embodiment (2) of the present invention can be prepared by mixing the paraffin wax, the amylolytic enzyme, and the enzyme activity stabilizer described above, setting a temperature of a mixture to a softening temperature (or melting point) of the paraffin wax or more, and cooling to solidify.

The paraffin wax, the amylolytic enzyme, and the enzyme activity stabilizer may be mixed all at once, but preferably the enzyme and the enzyme activity stabilizer may be firstly dissolved in water to provide a homogeneous solution, and the solution may be dehydrated by a freeze and dry method or the like, thereby the enzyme and the stabilizer can be mixed homogeneously. In this case, the obtained dry powder is mixed with the paraffin wax to provide an ungranulated mixture. Other conditions are the same as in embodiment (1).

Similarly as in embodiment (1), a detergent composition can contain the composite particle of embodiment (2) of the present invention.

Examples of the nonionic surfactant include nonionic surfactants similar to those used as the enzyme activity stabilizer described above. Preferred are polyoxyalkylene alkyl ethers obtained by adding 4 to 20 moles of alkylene oxide such as ethylene oxide or propylene oxide to an alcohol having 10 to 18 carbon atoms [those having an HLB value (calculated by the Griffin method) of 10.5 to 15.0, and preferably 11.0 to 14.5].

### EXAMPLES

The following Examples illustrate embodiments of the present invention. Examples are intended to exemplify the present invention and not to restrict the present invention.

In Examples, “%” and “part(s)” refer “% by weight” and “part(s) by weight”, respectively, unless otherwise indicated. Melting points of paraffin waxes were measured in accordance with JIS K0064: 1992. In Examples, the following materials were used.

borax: special grade/Wako Pure Chemical Industries, Ltd.

boric acid: special grade/Wako Pure Chemical Industries, Ltd.

ammonia water: 1 mol/L, Kanto Chemical Co., Inc.

casein: milk origin, SAJ 1st grade/Sigma-Aldrich Japan K.K.

gelatin: 1st grade/Wako Pure Chemical Industries, Ltd.

PVP K-90: polyvinylpyrrolidone, ISP TECHNOLOGIES, INC

PEG2000: polyethylene glycol, 1st grade/Wako Pure Chemical Industries, Ltd.

raw enzyme powder: freeze-dried raw powder of protease produced by Bacillus sp. KSM-KP43 (α-keratinolytic activity at 10° C.: 0.14×10⁻³ μg/mPU·min, α-keratinolytic activity at 30° C.: 0.49×10⁻³ μg/mPU·min)

paraffin: melting point 54 to 56° C., 1st grade/Wako Pure Chemical Industries, Ltd.

zirconia ball: diameter 1 mm, purchased from As One Corporation.

### Example 1

First, 2.0 g of borax as the enzyme activity stabilizer was mixed with 50 g of ion-exchanged water, and stirred with a spatula to uniformly dissolve. Then, to this was added 2.0 g of raw enzyme powder at an ambient (normal) temperature, and stirred with a spatula to uniformly dissolve. The resultant aqueous solution was subjected to a freeze and dry treatment to provide a raw composite powder containing the enzyme and the enzyme activity stabilizer. 0.9 g of raw composite powder, 29.1 g of paraffin as the paraffin wax, and 20.0 g of zirconia ball were weighed and placed in 100 mL polyethylene container. A mixture was heated in a hot bath at 75° C. to melt the paraffin, and in such a state, the polyethylene container was agitated to homogeneously mix the whole content. Agitation was performed about 900 times. The zirconia ball was removed with a sieve to provide a mixture of the stabilizer, the enzyme, and the paraffin. At the state in which the paraffin was molten (75° C.), the mixture was sprayed into the air at 25° C. through a double-fluid nozzle using nitrogen as a compressed gas. Cooled and solidified particles were collected and filtered through a sieve of 600 μm-mesh to remove coarse particles to provide a composite particle. A median particle diameter based on the volume of the composite particle was 209 μm.

### Example 2

A composite particle was obtained by the same method as in Example 1, except that an amount of borax added was 1.0 g. A median particle diameter based on the volume of the composite particle was 181 μm.

### Example 3

A composite particle was obtained by the same method as in Example 1, except that 2.27 g of boric acid and 7.35 g of 1 mol/L ammonia water were used as the enzyme activity stabilizer instead of borax. A median particle diameter based on the volume of the composite particle was 196 μm.

### Example 4

A composite particle was obtained by the same method as in Example 1, except that 1.135 g of boric acid and 3.68 g of 1 mol/L ammonia water were used as the enzyme activity stabilizer instead of borax. A median particle diameter based on the volume of the composite particle was 194 μm.

### Example 5

A composite particle was obtained by the same method as in Example 1, except that 2.0 g of casein instead of borax and 2.0 g of 1 mol/L ammonia water were used as the enzyme activity stabilizer. A median particle diameter based on the volume of the composite particle was 189 μm.

### Example 6

A composite particle was obtained by the same method as in Example 1, except that 2.0 g of gelatin was used as the enzyme activity stabilizer instead of borax. A median particle diameter based on the volume of the composite particle was 177 μm.

### Example 7

A composite particle was obtained by the same method as in Example 1, except that 1.0 g of borax and 1.0 g of casein were used as the enzyme activity stabilizer. A median particle diameter based on volume of the composite particle was 197 μm.

### Example 8

A composite particle was obtained by the same method as in Example 1, except that 0.4 g of borax and 2.0 g of casein were used as the enzyme activity stabilizer. A median particle diameter based on the volume of the composite particle was 169 μm.

### Example 9

A composite particle was obtained by the same method as in Example 1, except that 1.0 g of borax and 5.0 g of casein were used as the enzyme activity stabilizer. A median particle diameter based on the volume of the composite particle was 210 μm.

### Example 10

A composite particle was obtained by the same method as in Example 8, except that 1.8 g of raw composite powder of the enzyme and the enzyme activity stabilizer and 28.2 g of paraffin as the paraffin wax were weighed and placed in a 100 mL polyethylene container. A median particle diameter based on the volume of the composite particle was 204 μm.

### Example 11

A composite particle was obtained by the same method as in Example 9, except that 3.6 g of raw composite powder of the enzyme and the enzyme activity stabilizer and 26.4 g of paraffin as the paraffin wax were weighed and placed in a 100 mL polyethylene container. A median particle diameter based on the volume of the composite particle was 256 μm.

### Example 12

A composite particle was obtained by the same method as in Example 1, except that 4.0 g of casein and 4.0 g of 1 mol/L ammonia water were used as an enzyme activity-stabilizer instead of borax and 2.7 g of raw composite powder of the enzyme and the stabilizer and 27.3 g of paraffin as the paraffin wax were weighed and placed in a 100 mL polyethylene container. A median particle diameter based on the volume of the composite particle was 188 μm.

### Example 13

A composite particle was obtained by the same method as in Example 1, except that 1.0 g of PEG2000 was used as the enzyme activity stabilizer instead of borax. A median particle diameter based on the volume of the composite particle was 250 μm.

### Example 14

A composite particle was obtained by the same method as in Example 1, except that 1.0 g of PVP K-90 was used as the enzyme activity stabilizer instead of borax. A median particle diameter based on the volume of the composite particle was 208 μm.

### Example 15

A composite particle was obtained by the same method as in Example 1, except that 2.0 g of PVP K-90 was used as the enzyme activity stabilizer instead of borax. A median particle diameter based on the volume of the composite particle was 221 μm.

### Comparative Example 1

A composite particle was obtained by the same method as in Example 1, except that the enzyme activity stabilizer was not used.

That is, 0.9 g of raw enzyme powder, 29.1 g of paraffin as the paraffin wax, and 20.0 g of zirconia ball were weighed and placed in a 100 mL polyethylene container. A mixture was heated in a hot bath at 75° C. to melt the paraffin, and in such a state, the polyethylene container was agitated to homogeneously mix the whole content. Agitation was performed about 900 times. The zirconia ball was removed with a sieve to provide a mixture of the enzyme and the paraffin. At the state in which the paraffin was molten, the mixture was sprayed into the air at 25° C. through a double-fluid nozzle. Cooled and solidified particles were collected and filtered through a sieve of 600 μm-mesh to remove coarse particles to provide a composite particle. A median particle diameter based on the volume of the composite particle was 166 μm.

### Comparative Example 2

A composite particle was obtained by the same method as in Example 1, except that 1.0 g of boric acid was used as a comparative enzyme activity stabilizer instead of borax. A median particle diameter based on the volume of the composite particle was 254 μm.

### Comparative Example 3

The raw enzyme powder was used as is.

Compositions of composite particles obtained in Examples and Comparative Examples are shown together in Table 1

TABLE 1

| | | | | average particle |
|---|---|---|---|---|
| | | | | diameter of |
| | | | | composite particle |
| | | | Paraffin:enzyme:stabilizer | based on volume |
| | | Kind of stabilizer | (weight ratio) | (μm) |
| Example | 1 | Borax | 97:1.5:1.5 | 209 |
| | 2 | Borax | 97:2:1 | 181 |
| | 3 | Ammonium borate | 97:1.5:1.5 | 196 |
| | 4 | Ammonium borate | 97:2:1 | 194 |
| | 5 | Casein:ammonia = 1.5:0.03 | 97:1.5:1.53 | 189 |
| | 6 | Gelatin | 97:1.5:1.5 | 177 |
| | 7 | Casein:borax = 0.75:0.75 | 97:1.5:1.5 | 197 |
| | 8 | Casein:borax = 1.4:0.27 | 97:1.4:1.67 | 169 |
| | 9 | Casein:borax = 1.88:0.38 | 97:0.75:2.26 | 210 |
| | 10 | Casein:borax = 2.7:0.55 | 94:2.7:3.25 | 204 |
| | 11 | Casein:borax = 7.5:1.5 | 88:3:9 | 256 |
| | 12 | Casein:ammonia = 6:0.06 | 91:3:6.06 | 188 |
| | 13 | PEG2000 | 97:2:1 | 250 |
| | 14 | PVP K-90 | 97:2:1 | 208 |
| | 15 | PVP K-90 | 97:1.5:1.5 | 221 |
| Comparative | 1 | — | 97:3:0 | 166 |
| example | 2 | Boric acid | 97:2:1 | 254 |
| | 3 | — | 0:100:0 | — |

### Test Example 1

### Storage Test in Alkali Gel

0.3 g of acrylic acid-based thickener (ETD2020, BFGoodrich), 999.7 g of ion-exchanged water, and an appropriate amount of sodium hydroxide were mixed to provide an alkali gel of pH=11.0.

In a 10 mL screw vial, 0.1 g of the composite particle, obtained in Examples and Comparative Examples, and 1.0 g of alkali gel were incorporated, homogeneously mixed with spatula, and stored in a thermostatic chamber at 40° C. Only in the case of Comparative Example 3, 0.03 g of raw enzyme powder only was charged. Samples were stored for 7 days and measured for enzyme activity according to the following method to calculate a retention rate of enzyme activity. Results are shown in Table 2.

### <Measurement Method of Enzyme Activity>

### Preparation of Reagent:

(1) Phosphate Buffer

A Pack Of Phosphate Buffer Powder (Wako Pure Chemical Industries, Ltd. (for biochemistry 167-14491)) was dissolved in deionized water and set to 1 L using a measuring cylinder.

(2) 40 mmol/L Substrate Solution

498.1 mg of Glt-Ala-Ala-Pro-Leu-pNA (AAPL: PEPTIDE INSTITUTE, INC. (product No. 3129)) were dissolved in dimethylsulfoxide ((special grade): Wako Pure Chemical Industries, Ltd.) and set to 20 mL using a measuring flask.

(3) 5% Citric Acid Solution

50 g of citric acid (citric acid (anhydrous) (special grade): Wako Pure Chemical Industries, Ltd.) was dissolved in deionized water and set to 1 L using a measuring cylinder.

(4) 2 mmol/L Calcium Chloride Solution

0.22 g of calcium chloride ((anhydrous) (special grade) Wako Pure Chemical Industries, Ltd.)) was dissolved in deionized water and set to 1 L using a measuring cylinder.

### Preparation of Diluted Enzyme Solution (Blank)

In a 200 mL beaker, 0.1 g of the composite particle was measured (only in the case of Comparative Example 3, 0.03 g as an evaluation sample), and added with 54.9 g of cooled 2 mmol/L calcium chloride solution (only in the case of Comparative Example 3, 55.0 g). It was allowed to stand for 10 minutes in a hot bath at 60° C., lightly hand-shaken, and ice-cooled. The paraffin that molten and re-solidified was removed from the mixture. The mixture was used as a diluted enzyme solution.

### Preparation of Diluted Enzyme Solution (Storage Sample)

To an alkali gel dispersion (10 mL screw vial) as a storage sample was added a cooled 2 mmol/L calcium chloride solution. The alkali gel dispersion was all transferred into a 200 mL beaker. The vial was washed and a washing liquid was transferred into the beaker such that there was no residue of the alkali gel dispersion in the vial. A mixture prepared finally contained the alkali gel dispersion and 53.9 g of 2 mmol/L calcium chloride solution (only in the case of Comparative Example 3, 54.0 g). It was allowed to stand for 10 minutes in a hot bath at 60° C., lightly hand-shaken, and ice-cooled. The paraffin that became molten and re-solidified was removed from the mixture. The mixture was used as a diluted enzyme solution.

### Measurement of Enzyme Activity

To a test tube, 0.9 mL of phosphate buffer was placed, added with 0.05 mL of 40 mmol/L substrate solution, stirred with a test tube mixer and dipped in a thermostat bath at 30.0° C. The tube was maintained at the temperature for 5 minutes precisely measured with a stopwatch, added with 0.05 mL of the diluted enzyme solution, and stirred with a test tube mixer. The tube was maintained at 30.0° C. for an additional 10 minutes precisely measured with a stopwatch, added with 2 mL of 5% citric acid solution, and stirred with a test tube mixer. The mixture was then measured for absorbance at 420 nm with a spectrophotometer (Shimadzu Corporation, UV-2550).

### Calculation Method of Retention Rate of Enzyme Activity

A retention rate of enzyme activity was calculated according to the following formula (I).

retention rate of enzyme activity [%]=(absorbance of storage sample/absorbance of blank)×100 (I)

TABLE 2

| | Retention rate of enzyme |
|---|---|
| | activity in alkali gel |
| Kind of composite particle | (%) |
| composite particle of example 1 | 60 |
| composite particle of example 2 | 64 |
| composite particle of example 3 | 96 |
| composite particle of example 4 | 76 |
| composite particle of example 5 | 51 |
| composite particle of example 6 | 64 |
| composite particle of example 7 | 75 |
| composite particle of example 8 | 80 |
| composite particle of example 9 | 86 |
| composite particle of example 10 | 86 |
| composite particle of example 11 | 81 |
| composite particle of example 12 | 73 |
| composite particle of example 13 | 49 |
| composite particle of example 14 | 40 |
| composite particle of example 15 | 53 |
| composite particle of | 37 |
| comparative example 1 | |
| composite particle of | 4 |
| comparative example 2 | |
| Raw enzyme powder | 5 |
| of comparative example 3 | |

### Test Example 2

### Storage Test in Powder Detergent Composition

To 100 mL screw vials each were charged 5.0 g of test powder detergent composition as shown in Table 3 and 0.1 g each of the composite particles obtained in Examples 3, 5, 6, 8, 11, 12, and 15 and Comparative Example 1. Vials were lightly shaken to homogeneously mix the contents, and stored in a thermostat chamber at 40° C. Samples stored for 14 days were measured for enzyme activity by the following method to calculate a retention rate of enzyme activity. Results are shown in Table 4.

### <Measurement Method of Enzyme Activity>

Measurement was performed similarly as in Test Example 1, except that a preparation method of diluted enzyme solution was different.

### Preparation of Diluted Enzyme Solution (Blank)

In a 100 mL screw vial, 0.1 g of the composite particle and 5.0 g of test powder detergent composition that was stored for the same period under the same condition as of a storage sample were measured, and added with 54.9 g of cooled 2 mmol/L calcium chloride solution. It was allowed to stand for 10 minutes in a hot bath at 60° C., lightly hand-shaken, and ice-cooled. The mixture was filtrated through 0.45 μm filter (DISMIC 25CS045AN, Tokyo Glass Kikaki K.K.) and used as a diluted enzyme solution.

### Preparation of Diluted Enzyme Solution (Storage Sample)

A storage sample (100 mL screw vial) was added with 54.9 g of cool 2 mmol/L calcium chloride solution, allowed to stand for 10 minutes in a hot bath at 60° C., lightly hand-shaken, and ice-cooled. The mixture was filtrated through 0.45 μm cellulose filter and used as a diluted enzyme solution.

### Measurement of Enzyme Activity and Calculation Method of Retention Rate of Enzyme Activity

An enzyme activity was measured by the same method as in Test Example 1, and a retention rate of enzyme activity was similarly calculated according to the formula (I).

TABLE 3

| Composition of powder | Blend ratio |
|---|---|
| detergent composition | [%] |
| Polypropylene glycol¹⁾ | 2 |
| Trisodium citrate | 10 |
| Slat of acrylic acid/maleic acid | 3 |
| copolymer²⁾ | |
| α-amilase³⁾ | 2 |
| Sodium percarbonate | 10 |
| Sodium carbonate | 20 |
| Sodium silicate | 5 |
| Sodium sulfate | Balance |

¹⁾weight average molecular weight: about 3000, average polymerization degree: about 50 (diol type, Wako Pure Chemical Industries, Ltd.)
²⁾Sokalan CP45 (BASF Ltd.)
³⁾Termamyl60T (NovoNordisk Bioindustry Ltd.)

TABLE 4

| | Retention rate of enzyme activity |
|---|---|
| | in powder detergent composition |
| Kind of composite particle | (%) |
| Composite particle of example 3 | 39 |
| Composite particle of example 5 | 66 |
| Composite particle of example 6 | 75 |
| Composite particle of example 8 | 69 |
| Composite particle of example 11 | 92 |
| Composite particle of example 12 | 80 |
| Composite particle of example 15 | 59 |
| Composite particle of | 30 |
| comparative example 1 | |

From the results of Test Examples 1 and 2, it is clear that the composite particle of the present invention has excellent retention rate of enzyme activity in an alkali gel and in powder detergent composition.

raw enzyme powder 1: α-amylase/Wako Pure Chemical Industries, Ltd. (Bacillus subtilis, Pr.G.)

raw enzyme powder 2: freeze-dried raw powder of amylase produced by Bacillus sp. KSM-K38 according to the following method.

To a culture medium, a KSM-K38 strain (deposition No. 16817 (FERM P-16817)) was inoculated and aerobically cultured with shaking for two days at 30° C. To a supernatant of the cultured Bacillus sp. KSM-K38 strain was added ammonium sulfate such that a concentration thereof was 80% saturation concentration, and stirred. The generated precipitate was collected, dissolved in 10 mM Tris hydrochloric acid buffer (pH 7.5), and dialyzed with the same buffer overnight. The resultant dialysis inner liquid was adsorbed on a DEAE-Toyopearl 650M column that was equilibrated with the same buffer. Proteins were eluted with the same buffer with a concentration gradient of a salt of 0 to 1M. An active fraction was dialyzed with the same buffer and subjected to gel filtration column chromatography. The resultant active fraction was dialyzed with the same buffer to provide a purified enzyme that exhibited a single band in a polyacrylamide gel electrophoresis (gel concentration: 10%) and in a sodium dodecylsulfate (SDS) electrophoresis. It was further subjected to freezing and drying to provide a raw powder.

trehalose dihydrate: 1st grade/Wako Pure Chemical Industries, Ltd.

PVP K-90: polyvinylpyrrolidone, ISP TECHNOLOGIES, INC

casein: milk origin, SAJ 1st grade/Sigma-Aldrich Japan K.K.

ammonia water: 1 mol/L, Kanto Chemical Co., Inc.

Emulgen 320P: polyoxyethylene stearyl ether/Kao Corporation

paraffin wax: melting point 54 to 56° C., 1st grade/Wako Pure Chemical Industries, Ltd.

zirconia ball: diameter 1 mm, As One corporation

### Example 16

First, 2.0 g of trehalose dihydrate as the enzyme activity stabilizer was mixed with 50 g of ion-exchanged water, and stirred with a spatula to uniformly dissolve. Then, to this was added 2.0 g of raw enzyme powder 1 at an ambient (normal) temperature and stirred with a spatula to uniformly dissolve. The resultant aqueous solution was subjected to a freeze and dry treatment to provide a raw composite powder of the enzyme and the enzyme activity stabilizer. 1.8 g of raw composite powder, 28.2 g of paraffin wax, and 20.0 g of zirconia ball were weighed and placed in 100 mL polyethylene container. A mixture was heated in a hot bath at 75° C. to melt the paraffin, and in such a state, the polyethylene container was agitated to homogeneously mix the whole content. Agitation was performed about 900 times. The zirconia ball was removed with a sieve to provide a mixture of the enzyme activity stabilizer, the enzyme, and the paraffin wax. At the state in which the paraffin wax was molten (75° C.), the mixture was sprayed into the air at 25° C. through a double-fluid nozzle using nitrogen as a compressed gas. Cooled and solidified particles were collected and filtered through a sieve of 600 μm-mesh to remove coarse particles to provide a composite particle. A median particle diameter based on the volume of the composite particle was 248 μm.

### Example 17

A composite particle was obtained by the same method as in Example 16, except that PVP K-90 was used as the enzyme activity stabilizer instead of trehalose dihydrate and raw enzyme powder 2 was used as the raw enzyme powder. A median particle diameter based on the volume of the composite particle was 265 μm.

### Example 18

A composite particle was obtained by the same method as in Example 17, except that 4.0 g of casein and 4.0 g of 1N ammonia were was used as the enzyme activity stabilizer instead of PVP K-90 and amounts of the raw composite powder and the paraffin wax were 2.7 g and 27.3 g, respectively. A median particle diameter based on the volume of the composite particle was 209 μm.

### Example 19

A composite particle was obtained by the same method as in Example 18, except that 4.0 g of Emulgen 320P was used as the enzyme activity stabilizer. A median particle diameter based on the volume of the composite particle was 205 μm.

### Comparative Example 4

0.9 g of raw enzyme powder 1, 29.1 g of paraffin wax, and 20.0 g of zirconia ball were weighed and placed in 100 mL polyethylene container. A mixture was heated in a hot bath at 75° C. to melt the paraffin wax, and in such a state, the polyethylene container was agitated to homogeneously mix the whole content. Agitation was performed about 900 times. The zirconia ball was removed with a sieve to provide a mixture of the enzyme and the paraffin wax. At the state in which the paraffin wax was molten, the mixture was sprayed into the air at 25° C. through a double-fluid nozzle using nitrogen as a compressed gas. Cooled and solidified particles were collected and filtered through a sieve of 600 μm-mesh to remove coarse particles to provide a composite particle. A median particle diameter based on the volume of the composite particle was 253 μm.

### Comparative Example 5

A composite particle was obtained by the same method as in Comparative Example 4, except that the raw enzyme powder 2 was used as the raw enzyme powder. A median particle diameter based on the volume of the composite particle was 229 μm.

### Comparative Example 6

The raw enzyme powder 1 was used as is.

### Comparative Example 7

The raw enzyme powder 2 was used as is.

Compositions of the composite particle obtained in Examples 16 to 19 and Comparative Examples 4 to 7 are listed in Table 5 together.

TABLE 5

| | | | | | Median particle |
|---|---|---|---|---|---|
| | | | | | diameter based on |
| | | | | Paraffin wax:enzyme:enzyme activity | volume of composite |
| | | | Kind of enzyme | stabilizer | particle |
| | | Kind of enzyme | activity stabilizer | (weight ratio) | (μm) |
| Example | 16 | Raw enzyme powder 1 | Trehalose dihydrate | 94:3:3 | 248 |
| | 17 | Raw enzyme powder 2 | PVP K-90 | 94:3:3 | 265 |
| | 18 | Raw enzyme powder 2 | Casein/ammonia | 91:3:6 | 209 |
| | 19 | Raw enzyme powder 2 | Emulgen 320P | 91:3:6 | 205 |
| Comparative example | 4 | Raw enzyme powder 1 | — | 97:3:0 | 253 |
| | 5 | Raw enzyme powder 2 | — | 97:3:0 | 229 |
| | 6 | Raw enzyme powder 1 | — | 0:100:0 | — |
| | 7 | Raw enzyme powder 2 | — | 0:100:0 | — |

### Test Example 3

### Storage Test in Alkali Gel

0.3 g of acrylic acid-based thickener (ETD2020, BFGoodrich), 999.7 g of ion-exchanged water, and appropriate amount of sodium hydroxide were mixed to provide an alkali gel of pH=11.0.

For respective composite particles obtained in Examples 16 to 19 and Comparative Examples 4 to 7, in a 10 mL screw vial, 0.1 g of composite particle and 1.0 g of alkali gel were charged, homogeneously mixed with a spatula, and stored in a thermostatic chamber at 40° C. Only in the cases of Comparative Examples 6 and 7, 0.03 g of raw enzyme powder only was charged. Samples were stored for up to 28 days and measured for enzyme activity according to the following method to calculate a retention rate of enzyme activity. Results are shown in Table 6.

### <Measurement Method of Enzyme Activity>

### Measurement Reagent

(1) Britton Robinson buffer (pH 8.5)

(2) Neo-amylase test (Daiichi Pure Chemical Co., Ltd.)

(3) sodium hydroxide (1N)

### Preparation of Diluted Enzyme Solution (Blank)

In a 200 mL tall beaker, 0.1 g of composite particle (only in the cases of Comparative Examples 6 and 7, 0.03 g of raw enzyme powder, stored at room temperature) and 54.9 g of Britton Robinson buffer were mixed, heat treated for 10 minutes in a hot bath at 60° C., and ice-cooled. The paraffin that became molten and re-solidified was removed from the mixture. The mixture was used as a diluted enzyme solution.

### Preparation of Diluted Enzyme Solution (Storage Sample)

To an alkali gel dispersion (10 mL screw vial) as a storage sample was added cooled Britton Robinson buffer. The alkali gel was all transferred into a 200 mL beaker. The vial was washed and a washing liquid was transferred into the beaker such that there was no residue of the alkali gel dispersion in the vial. A mixture prepared finally contained the alkali gel dispersion and 53.9 g of Britton Robinson buffer. It was allowed to stand for 10 minutes in a hot bath at 60° C. and ice-cooled. The paraffin that became molten and re-solidified was removed from the mixture. The mixture was used as a diluted enzyme solution.

### Measurement of Enzyme Activity

A test tube containing 4 mL of Britton Robinson buffer and a tablet of Neo-amylase test was stirred for 10 seconds with a test tube mixer. To this was added 0.05 mL of diluted enzyme solution, held at 50° C. for 15 minutes in a hot bath, added with 0.9 mL of sodium hydroxide (1N), and cooled. It was subjected to centrifugation (1500 rpm, for 5 minutes) to provide a supernatant, which was measured for absorbance at 620 nm with a spectrophotometer (Shimadzu Corporation, UV-2550).

### Calculation Method of Retention Rate of Enzyme Activity

A retention rate of enzyme activity was calculated according to the following formula (I).

retention rate of enzyme activity [%]=(absorbance of storage sample/absorbance of blank)×100 (I)

TABLE 6

| | | Retention rate of |
|---|---|---|
| Composite particle | | enzyme activity |
| or kind of raw | | storage term |
| particle powder | Kind of enzyme | parenthesized |
| Composite powder | Raw enzyme powder 1 | 79% (28 days) |
| of example 1 | | |
| Composite powder | Raw enzyme powder 1 | 38% (28 days) |
| of comparative example 1 | | |
| Composite powder | Raw enzyme powder 1 | 2% (1 day) |
| of comparative example 3 | | |
| Composite powder | Raw enzyme powder 2 | 45% (28 days) |
| of example 2 | | |
| Composite powder | Raw enzyme powder 2 | 35% (28 days) |
| of example 3 | | |
| Composite powder | Raw enzyme powder 2 | 33% (28 days) |
| of example 4 | | |
| Composite powder | Raw enzyme powder 2 | 19% (28 days) |
| of comparative example 2 | | |
| Raw enzyme powder | Raw enzyme powder 2 | 4% (7 days) |
| of comparative example 4 | | |

From the results of Test Example 3, it is clear that the composite particle of the present invention has excellent retention rate of enzyme activity in an alkali gel.

1. A composite particle comprising:
a paraffin wax and
(1) a proteolytic enzyme and
(1e) at least one or more enzyme activity stabilizer selected from the group consisting of borates, proteins, polyhydric alcohols and water-soluble polymers, or
(2) an amylolytic enzyme and
(2e) at least one or more enzyme activity stabilizer selected from the group consisting of polyhydric alcohols, nonionic surfactants and water-soluble polymers.

2. The composite particle according to claim 1, wherein the content of the enzyme activity stabilizer is 1 to 1000 parts by weight to 100 parts by weight of proteolytic enzyme (1) or amylolytic enzyme (2).

3. The composite particle according to claim 1 or 2, which comprises the proteolytic enzyme (1) and is spherical, having a median particle diameter, based on volume, of 100 μm or more.

4. The composite particle according to claim 1 or 2, which comprises the amylolytic enzyme (2) and is spherical, having a median particle diameter, based on volume, of 100 μm or more and 5 mm or less.

5. A process for preparing the composite particle according to any of claims 1 to 4, comprising steps of mixing the paraffin wax with the proteolytic enzyme (1) and enzyme activity stabilizer (1e) or with the amylolytic enzyme (2) and enzyme activity stabilizer (2e); adjusting a temperature of the mixture to a softening temperature (or melting point) of the paraffin wax or more; and subjecting the mixture to cooling solidification to granulate.

6. The process according to claim 5, wherein the mixture of the paraffin wax, proteolytic enzyme (1) and enzyme activity stabilizer (1e) is obtained by firstly preparing a homogeneous aqueous solution of the proteolytic enzyme and the enzyme activity stabilizer, dehydrating the aqueous solution to produce a dry powder and mixing the powder with the paraffin wax at a softening temperature (or melting point) or more of the paraffin wax.

7. The process according to claim 5, wherein the mixture of the paraffin wax, amylolytic enzyme (2) and enzyme activity stabilizer (2e) is obtained by firstly preparing a homogeneous aqueous solution of the proteolytic enzyme and the enzyme activity stabilizer, dehydrating the aqueous solution to produce a dry powder and mixing the powder with the paraffin wax at a softening temperature (or melting point) or more of the paraffin wax.

8. The process according to any of claims 5 to 7, wherein granulation by cooling and solidifying is performed by subjecting the mixture of a temperature equal to or higher than a softening temperature (or melting point) of the paraffin wax to melt spray cooling to granulate.

9. A detergent composition comprising the composite particle according to any of claims 1 to 4 or the composite particle obtained by the process according to any of claims 5 to 8.
